(19) United States
(12) Patent Application Publication
(10) Pub. No.: US 2024/0401405 A1
(43) Pub. Date: Dec. 5, 2024

(54) CONTROLLER FOR CONTROLLING ASCENDING/DESCENDING OF A ROLLER SHADE

(71) Applicant: SHANG HUI MACHINERY CO., LTD., Kaohsiung City (TW)

(72) Inventor: Ming-Lu WONG, Kaohsiung City (TW)

(21) Appl. No.: 18/325,754

(22) Filed: May 30, 2023

(51) Int. Cl. E06B 9/90; E06B 9/42

(52) U.S. Cl. CPC E06B 9/42; E06B 9/78

(57) ABSTRACT

A controller for controlling ascending/descending of a roller shade includes a switch box, a loop-shaped drive cord, a cord biting unit and a control rod. The drive cord is conducted through the switch box, whereby two cord sections of the drive cord are controlled by the cord biting unit. After conducted through the switch box, the drive cord is connected with a spring and concealed in the control rod. By means of rotating the control rod, a slide seat of the cord biting unit is driven to transversely displace toward one side so as to selectively push any of the clamp blocks of the cord biting unit to rotate along an arcuate line. At this time, the clamp teeth and restriction recess of the clamp block are moved downward away from the cord section. Synchronously, a spring applies elastic force to the clamp block not pushed by the slide seat to push and rotate the clamp block upward along an arcuate line, whereby the clamp teeth and the curved edges produced on two sides of the restriction recess together hold and bite a cord knot of the surface of one of the cord sections. The control rod is used to pull the bitten cord section of the drive cord so as to drive a cord winder to rotate and control the roller shade to move upward or downward.

### FIELD OF THE INVENTION

The present invention relates generally to a controller for controlling ascending/descending of a roller shade, and more particularly to a controller, in which the drive cord is concealed in the control rod so as to prevent a child from pulling the drive cord and twisting the drive cord around the child's neck.

### DESCRIPTION OF THE RELATED ART

A conventional roller shade often employs a bead chain controller or a pull cord to control ascending/descending of the roller shade fabric. The bead chain controller is drivingly connected with a roller shade tube. When pulling the bead chain, the bead chain controller is rotated to drive and rotate the roller shade tube so as to lift or lower the roller shade fabric. When the bead chain controller stops driving and moving the roller shade fabric, the bead chain of the bead chain controller naturally suspends from one side of a window to a lower edge of the window without being located. The bead chain is not secured so that a space sufficient for the bead chain to twist around a neck is exposed. As a result, it is easy for a child to pull the bead chain and twist the bead chain around the child's neck to cause fatal injury. Therefore, in use of the conventional roller shade, the suspending bead chain may lead to unexpected danger.

In order to solve the problem that the conventional bead chain is not secured so that a child may twist the bead chain around the child's neck to cause danger, a bead chain securing device has been developed. Such bead chain securing device has a securing unit disposed at the tail end of the suspending bead chain. The securing unit is fixed on the wall to locate the bead chain and prevent a child from pulling the bead chain and twisting the bead chain around the child's neck. Such securing unit can locate the bead chain. However, the bead chain exposed to outer side still has a gap so that a sufficiently large dangerous space still exists to allow a child to pull the bead chain and twist the bead chain around the child's neck. Moreover, it often takes place that the securing unit is not installed as required. In this case, the bead chain will still threaten the life of the child. Therefore, the conventional bead chain securing device is not an optimal design.

### SUMMARY OF THE INVENTION

It is therefore a primary object of the present invention to provide a roller shade controller, in which the drive cord is concealed in a control rod so as to effectively prevent a child from pulling the drive cord and enhance safety effect. The roller shade controller includes a drive cord wound on a cord winder of the roller shade. Two cord sections between a top end section and a rear end section of the drive cord are separated by a guide seat with two rows of dentations on two sides, whereby the two cord sections are positioned between the guide seat and two clamp blocks having clamp teeth and restriction recesses. The two cord sections are passed through a slide seat driven by the control rod by means of rotating the control rod. The rear end section of the drive cord is conducted into the control rod and concealed therein. The rear end section of the drive cord is connected with a spring to keep the drive cord circularly movable. By means of rotating the control rod, the slide seat is driven to transversely displace, whereby a push body of the slide seat selectively pushes any of the clamp blocks of the cord biting unit to rotate downward. At this time, the clamp teeth on the protruding block protruding from the clamp block and the restriction recess formed along the middle line of the clamp teeth of the clamp block are rotated downward along an arcuate line away from the cord section. When the slide seat is transversely displaced toward one side, a spring applies elastic force to the clamp block not pushed by the slide seat to push and rotate the clamp block upward along an arcuate line, whereby the clamp teeth and the restriction recess on the protruding block get closer to the row of dentations of the guide seat so that the clamp teeth of the protruding block and the curved edges produced on two sides of the restriction recess together hold and bite a cord knot of the surface of the drive cord. The dentations of the guide seat cooperatively clamp the cord section from two sides to restrict the sliding direction of the cord section, whereby the cord section is clamped and located on the switch box to form a pull end. The control rod and the switch box are used to pull the drive cord so as to drive a rotary shaft of the cord winder of the roller shade to rotate and operate the roller shade to move upward or downward. The drive cord is concealed so as to prevent a child from pulling the drive cord or a pull cord and twisting the drive cord around the child's neck. Therefore, the safety effect is enhanced.

To achieve the above and other objects, the present invention provides a controller for controlling ascending/descending of a roller shade. The controller includes a switch box, a drive cord, a cord biting unit and a control rod. The switch box is composed of a first case body and a second case body. Each of upper and lower ends of the first and second case bodies has a dent. After the first and second case bodies are assembled with each other, an opening is formed at each of the upper and lower ends of the switch box. Two protruding posts are respectively disposed on two lateral sides of the upper end opening. An elongated channel is formed at a middle portion of each of the first and second case bodies. The two elongated channels are correspondingly assembled with each other. The drive cord has the form of a loop body. A top end section of the drive cord is wound on a cord winder of the roller shade. The drive cord serves to drive the cord winder to clockwise rotate or counterclockwise rotate so as to control ascending/descending of the roller shade. A rear end section of the drive cord is conducted through the opening of the upper end of the switch box into the switch box and then conducted out of the switch box through the opening of the lower end of the switch box. Two lateral sections of the drive cord are enclosed in the switch box. The cord biting unit includes a guide seat, a clamp block set fitted on the protruding posts of the first case body. The guide seat is disposed at an inlet end of the opening of the upper end of the switch box. The guide seat is a substantially triangular body and two rows of dentations are formed on two sides of the guide seat, whereby the opening of the upper end of the switch box is divided into two inlets. The clamp block set includes a first clamp block and a second clamp block respectively disposed on two sides of the guide seat. A slide seat is disposed under the guide seat. Two lateral cord sections of the drive cord are respectively conducted into the switch box and separated from each other. The two lateral cord sections are respectively positioned in the passages between the first and second clamp blocks and the guide seat. The first and second clamp blocks are rotatably fitted on the protruding posts. A lower side of each of the first and second clamp blocks has a boss body. A protruding block protrudes from a lateral side of each of the first and second clamp blocks. Clamp teeth are disposed on the protruding block. A restriction recess is formed along a middle line of the clamp teeth. A spring is disposed on one side of each of the first and second clamp blocks opposite to the clamp teeth so as to provide elastic force for pushing the first and second clamp blocks. The slide seat is positioned in the elongated channel of the middle portion of the switch box. Two restriction arms are respectively formed on two sides of the slide seat for stabilizing the transverse sliding of the slide seat. A linking seat perpendicularly protrudes from the slide seat. Multiple engagement teeth are formed on an end face of the linking seat. A drive body is disposed at an upper end of the control rod. The drive body has multiple engagement bodies corresponding to the engagement teeth, whereby the engagement teeth are engaged with the engagement bodies. When rotating the control rod, the engagement bodies of the drive body drive the engagement teeth so as to drive the slide seat to transversely displace. In addition, multiple engagement teeth are disposed at the upper end of the linking seat of the slide seat. The engagement teeth cooperate with a locating unit to limit the moving distance of the slide seat. A push body protrudes from one end of the slide seat opposite to the engagement teeth. The push body is synchronously transversely movable along with the slide seat to selectively push the boss body of the lower side of the first clamp block or the boss body of the lower side of the second clamp block. The control rod is a hollow tubular body. The drive body is disposed at the top end of the hollow tubular body. The engagement bodies are formed on the drive body for drivingly engaging with the engagement teeth of the linking seat of the slide seat. A rear end section of the drive cord is conducted into the control rod and connected with a cord conducting seat and a spring and located at a rear end of the control rod. The rear end section of the drive cord is concealed in an internal space of the control rod. A tube cap is fitted in a tail end of the control rod to block the internal space thereof.

With respect to the technical theory of the present invention, the top end section of the loop-shaped drive cord is wound on the cord winder of the roller shade, while the rear end section of the drive cord is conducted through the switch box and concealed in the control rod. When rotating the control rod, the slide seat is driven to selectively transversely move to one side. At this time, the push body of the slide seat selectively pushes the first clamp block or the second clamp block of the clamp block set of the cord biting unit to rotate along an arcuate line around the protruding post of the first case body. When the first clamp block is pushed and displaced, the protruding block extending from the lateral side of the first clamp block is downward displaced along an arcuate line along with the first clamp block, whereby the clamp teeth of the protruding block and the restriction recess formed along the middle line of the clamp teeth are rotated downward along an arcuate line away from the cord section, while the second clamp block is not pushed by the push body. At this time, the spring applies elastic force to the second clamp block to push the boss body of the lower side of the second clamp block, whereby the second clamp block is counterclockwise rotated around the protruding post of the first case body. At the same time, the protruding block is upward displaced along an arcuate line along with the second clamp block. Accordingly, the clamp teeth of the protruding block and the curved edges produced on two sides of the restriction recess formed along the middle line of the clamp teeth together hold and bite a cord knot of the surface of the drive cord to clog the cord section thereof. The clamp teeth of the protruding block and the row of dentations of the guide seat clamp the cord section from two sides to restrict the sliding of the cord section and form a pull end. Under such circumstance, the control rod and the switch box can be used to pull down the clamped drive cord and drive the cord winder of the roller shade to rotate so as to control ascending/descending of the roller shade. Also, the downward pulling force of the cord section will push the clamp block away to release the drive cord from the biting state. Due to the restoring pull force of the spring connected with the drive cord, the drive cord is pulled downward, whereby the control rod and the switch box are synchronously moved upward and restored to their home position for selectively moving the roller shade up or down. The operation can be repeated to control ascending/descending of the roller shade.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective view of the slide seat of the present invention;

FIG. 3 is a perspective view of the clamp block set of the present invention;

FIG. 4 is a plane view showing the assembly of the present invention;

FIG. 5 is a perspective view of the controller of the present invention;

FIG. 6 is a perspective view showing that the controller of the present invention is connected with a cord winder of a roller shade;

FIG. 7 is a side view showing that the controller of the present invention is connected with a cord winder of a roller shade;

FIG. 8 is a view showing the locating unit of the present invention;

FIG. 9 is a side view showing the operation of the present invention;

FIG. 10 is a view showing that the cord winder is counterclockwise rotated;

FIG. 11 is a view showing that the slide seat of the present invention is transversely displaced; and

FIG. 12 is a view showing that the cord winder is clockwise rotated.

### DETAILED DESCRIPTION OF THE PREFERRED EMBODIMENTS

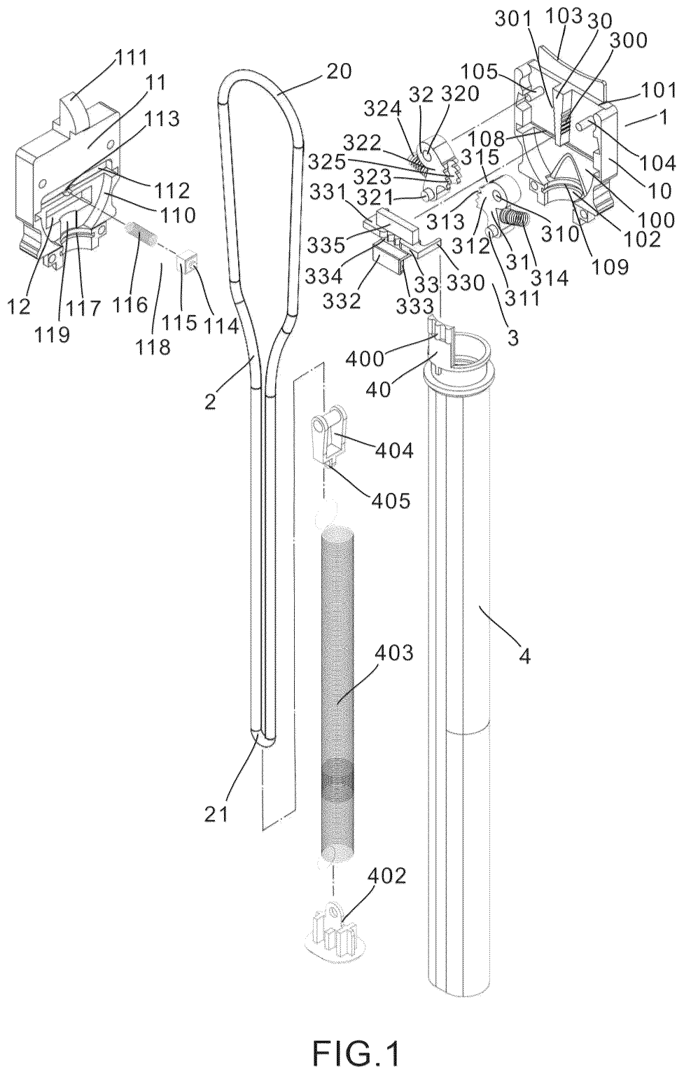

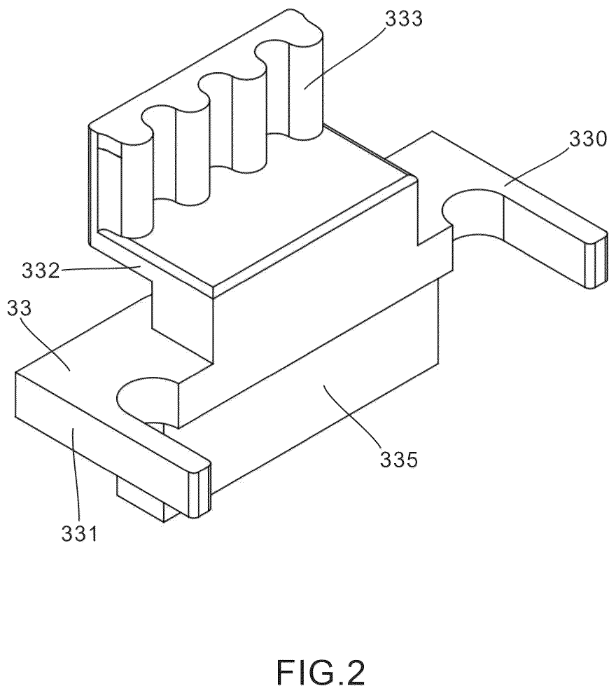

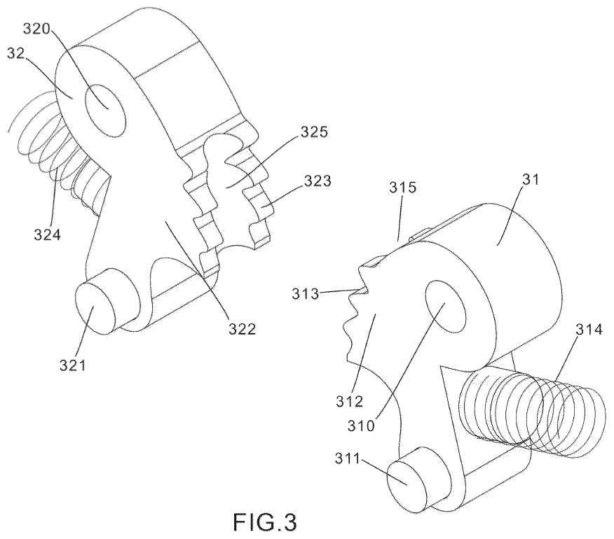

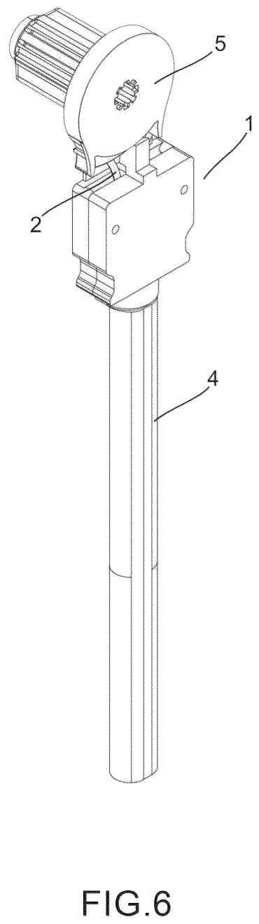

Please refer to FIG. 1. The present invention includes a switch box 1, a loop-shaped drive cord 2, a cord biting unit 3 and a control rod 4. The switch box 1 includes a first case body 10 and a second case body 11. An inner face of the first case body 10 is formed with an inward recessed structure 100. An upper end and a lower end of the inward recessed structure 100 are respectively formed with an upper end dent 101 and a lower end dent 102. A locating plate 103 protrudes from an outer side of the upper end dent 101. In addition, two protruding posts 104, 105 are disposed on two lateral sides of the upper end dent 101. An inner face of the second case body 11 is also formed with an inward recessed structure 110. A locating body 111 protrudes from an upper end of the second case body 11. An elongated channel 108 and an elongated channel 112 are respectively formed at middle portions of the inward recessed structures 100, 110 of the first and second case bodies 10, 11. The two elongated channels 108, 112 correspond to each other, whereby after the first and second case bodies 10, 11 are assembled with each other, a receiving space is defined between the first and second case bodies 10, 11. A receiving sink 113 is further formed on a bottom of the elongated channel 112 of the second case body 11. A locating unit 118 is positioned in the receiving sink 113. The locating unit 118 is composed of a cap body 115 with an abutment column 114 and an elastic member 116. By means of the elastic member 116, the abutment column 114 has elasticity. In addition, a restriction channel 109 and a restriction channel 117 are respectively formed at lower ends of the first and second case bodies 10, 11 near the lower end dents. A top end structure of the control rod 4 is received in the restriction channels 109, 117, whereby the top end structure of the control rod 4 is rotatably held between the first and second case bodies 10, 11 and connected with the switch box 1. An arcuate depression 119 is formed above the restriction channel 117 of the second case body 11 in communication with a receiving cavity 12. A linking seat 332 of a slide seat 33 of the cord biting unit 3 is received in the receiving cavity 12. When the first and second case bodies 10, 11 are assembled with each other by means of securing members to form the switch box 1, two openings are respectively formed at the upper and lower ends of the switch box 1 and a receiving space is defined in the switch box 1. The drive cord 2 has the form of a loop body having a top end section 20 and a rear end section 21. The top end section 20 of the drive cord 2 is wound on a cord winder (with reference to FIG. 6). The drive cord 2 serves to drive the cord winder 5 to clockwise rotate or counterclockwise rotate so as to control ascending/descending of the roller shade. The rear end section 21 of the drive cord 2 is conducted through the opening of the upper end of the switch box 1 into the switch box 1 and then conducted out of the switch box 1 through the opening of the lower end of the switch box 1. Two lateral sections of a middle portion of the drive cord 2 are enclosed in the switch box 1. The cord biting unit 3 is disposed in the internal space of the switch box 1. The cord biting unit 3 includes a guide seat 30 and a clamp block set fitted on the protruding posts 104, 105 of the first case body 10. The clamp block seat includes a first clamp block 31, a second clamp block 32 and a slide seat 33. The guide seat 30 is disposed at an inlet end of the opening of the upper end of the switch box 1 and extends to an edge of the elongated channel 108 of the first case body 10. The guide seat 30 is a substantially triangular structure with a wider upper end and a narrower lower end. Two rows of dentations 300, 301 are disposed on two sides of the guide seat 30 through the thickness thereof. The dentations 300, 301 respectively correspond to the first and second clamp blocks 31, 32 of the clamp block set to form two passages for the cord sections of the drive cord 2 to pass through. The main bodies of the first and second clamp blocks 31, 32 are respectively formed with two through holes 310, 320 (with reference to FIGS. 1 and 3). The protruding posts 104, 105 of the first case body 10 are fitted in the through holes 310, 320, whereby the first and second clamp blocks 31, 32 are rotatable. A board block extends from a lower end of each of the first and second clamp blocks 31, 32. A boss body 311, 321 is disposed on the board block. In addition, a protruding block 312, 322 protrudes from a lateral side of each of the first and second clamp blocks 31, 32. Clamp teeth 313, 323 are disposed on outer edges of the protruding blocks 312, 322. The clamp teeth 313, 323 are structures with different depths and are positioned on different arcuate lines. A restriction recess 315, 325 is additionally formed along the middle line of the clamp teeth 313, 323, whereby the restriction recesses 315, 325 and the clamp teeth 313, 323 produce curved edges. A spring 314, 324 is disposed on the board block of the lower end of each of the first and second clamp blocks 31, 32 to correspondingly connect with the inner face of the first case body 10 so as to provide elastic force for the first and second clamp blocks 31, 32, whereby the first and second clamp blocks 31, 32 can rotate along an aucuate line. The slide seat 33 is positioned in the elongated channel 108 of the middle portion of the switch box 1 (as shown in FIGS. 1 and 2). Two restriction arms 330, 331 are respectively formed on two sides of the slide seat 33 for stabilizing the transverse sliding of the slide seat 33. A cord passing space 336 is defined between inner edges of the two restriction arms 330, 331 for two cord sections to pass through. In addition, a linking seat 332 perpendicularly protrudes from the slide seat 33. The linking seat 332 is received in the receiving cavity 12 of the second case body 11. Multiple engagement teeth 333 are formed on an inner face of the linking seat 332. A drive body 40 is disposed at an upper end of the control rod 4. The drive body 40 has multiple engagement bodies 400 correspondingly engaged with the engagement teeth 333, whereby when rotating the control rod 4, the engagement bodies 400 of the drive body 40 drive the engagement teeth 333 so as to drive the slide seat 33 to transversely displace. In addition, multiple engagement teeth 334 and a push body 335 are disposed at the upper end of the linking seat 332 of the slide seat 33. The engagement teeth 334 cooperate with the abutment column 114 of the locating unit 118 to limit the moving distance of the slide seat 33. The push body 335 is transversely displaced to selectively push the boss body 311 of the lower side of the first clamp block 31 or the boss body 321 of the lower side of the second clamp block 32, whereby the first clamp block 31 or the second clamp block 32 is rotated along an arcuate line. At this time, the clamp teeth 313, 323 are synchronously upward or downward displaced along an arcuate line. The control rod 4 is designed as a hollow tubular body. The drive body 40 is disposed at the top end of the hollow tubular body. The engagement bodies 400 are formed on the drive body 40 for engaging with the engagement teeth 333 of the slide seat 33. In addition, a tube cap 402 is securely fitted in a tail end of the hollow tubular body. A top end of the tube cap 402 is securely connected with a bottom end of a spring 403. A top end of the spring 403 is securely connected with a perforation 405 of a cord conducting seat 404. The rear end section 21 of the drive cord 2 is conducted through a conducting space defined by the cord conducting seat 404 to connect with the spring 403.

With reference to FIGS. 1, 2 and 3, the present invention is assembled by means of the following steps:

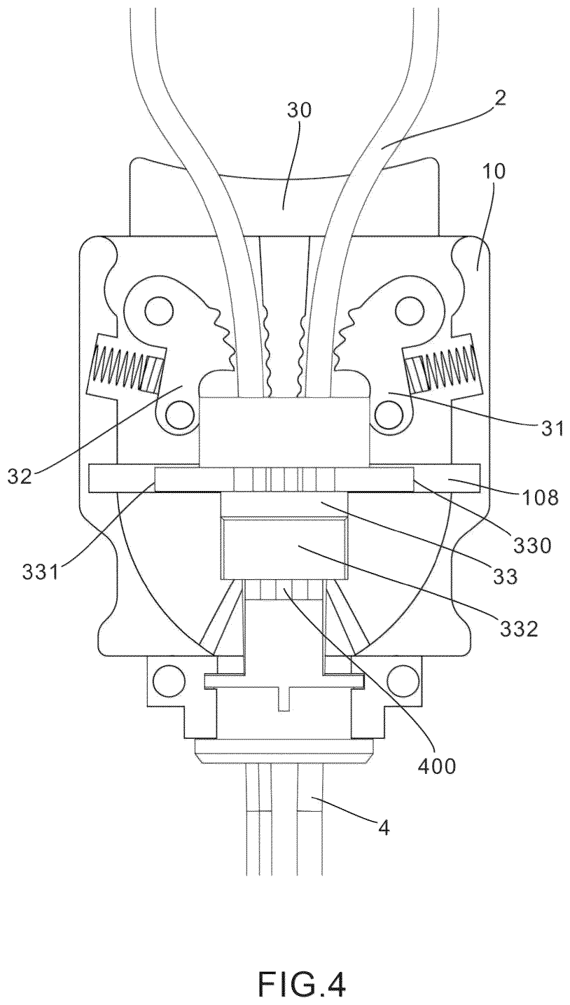

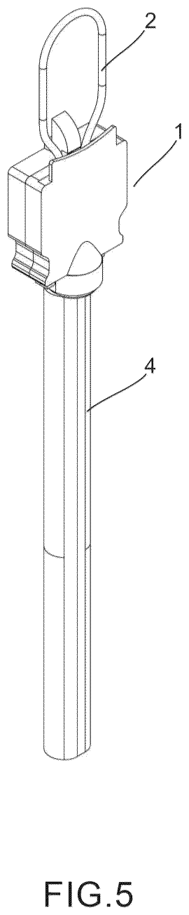

The two cord sections of the middle portion of the loop-shaped drive cord 2 are respectively arranged in the two inlets of the first case body 10, whereby the top end section 20 outward protrudes from the inlets of the first case body 10. Then the two cord sections are conducted through the passage defined by the first and second clamp blocks 31, 32 and the guide seat 30 to pass through the elongated channel 108 of the first case body 10. Then the slide seat 33 is placed into the elongated channel 108, whereby the two cord sections are conducted through the cord passing space 336 between the restriction arms 330, 331 on two sides of the slide seat 33. In addition, the rear end section 21 of the drive cord 2 is conducted through the opening of the tail end of the first case body 10 and finally conducted into the hollow tubular body of the control rod 4 to connect with the cord conducting seat 404. The top end of the spring 403 is securely connected with the perforation 405 of the lower end of the cord conducting seat 404. The rear end of the spring 403 is located by means of the tube cap 402 (as shown in FIG. 1). Accordingly, the rear end section 21 of the drive cord 2 and the spring 403 are enclosed in the control rod 4. At this time, the drive cord 2 is movable. Thereafter, the upper end structure of the control rod 4 is connected in the restriction channel 109 of the first case body 10. Also, the engagement bodies 400 of the drive body 40 are drivingly engaged with the engagement teeth 333 of the linking seat 332 of the slide seat 33 (with reference to FIGS. 1 and 3). After the drive cord 2 and the cord biting unit 3 and the control rod 4 are all arranged in the inward recessed structure 100 of the first case body 10, the second case body 11 is mated with the first case body 10. The assembled main body of the switch box 1 is connected with the control rod 4 by means of securing members (with reference to FIGS. 4 and 5). Finally, the top end section 20 of the drive cord 2, which extends out of the switch box 1, is hung on the cord winder 5. In this case, by means of rotating and pulling the control rod 4, the roller shade can be controlled and selectively moved upward or downward (as shown in FIG. 6).

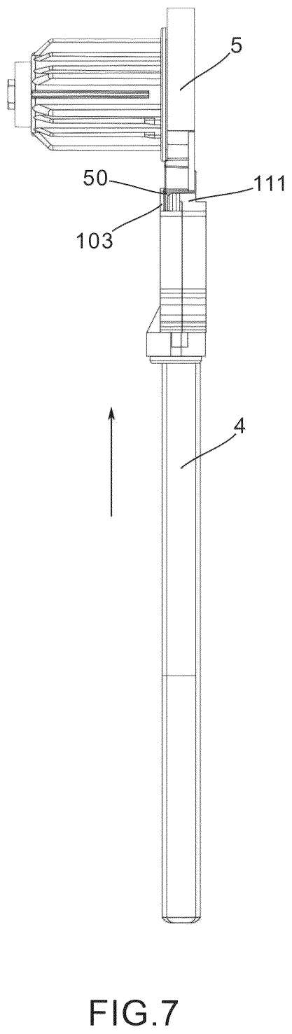

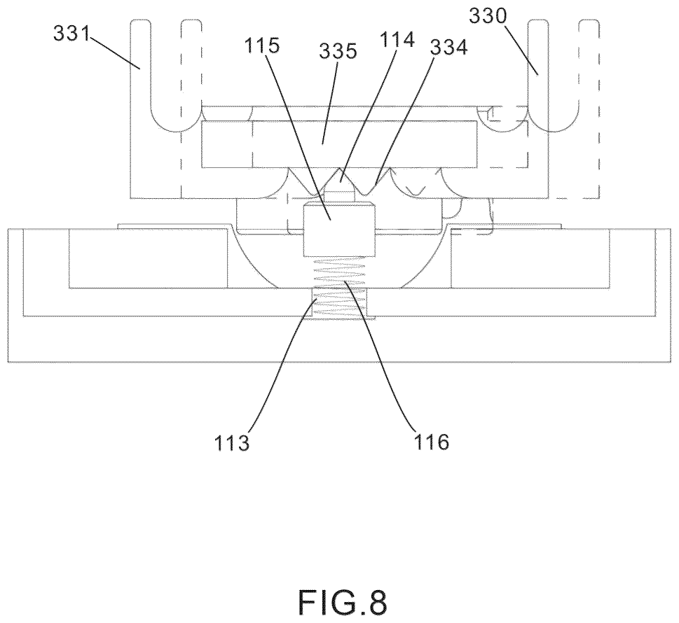

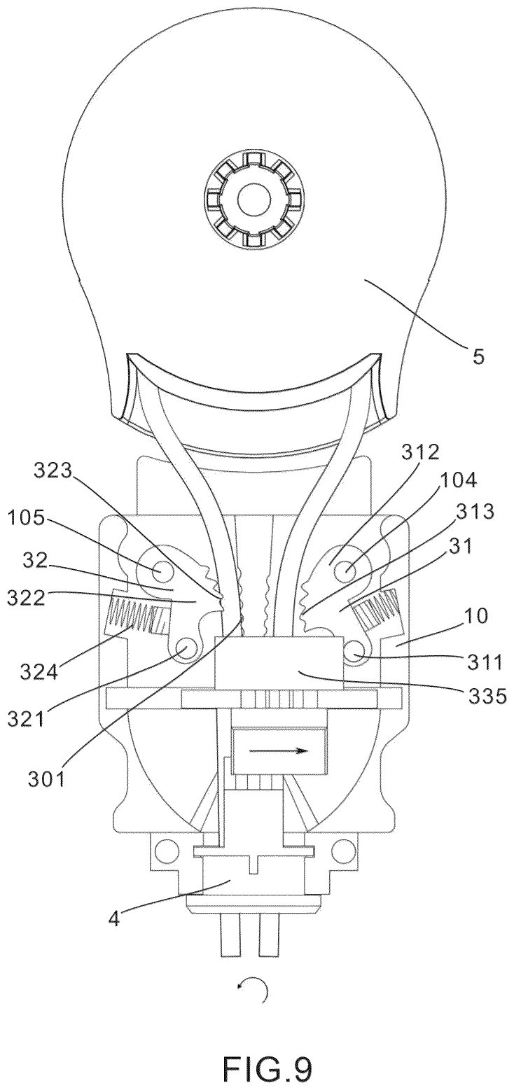

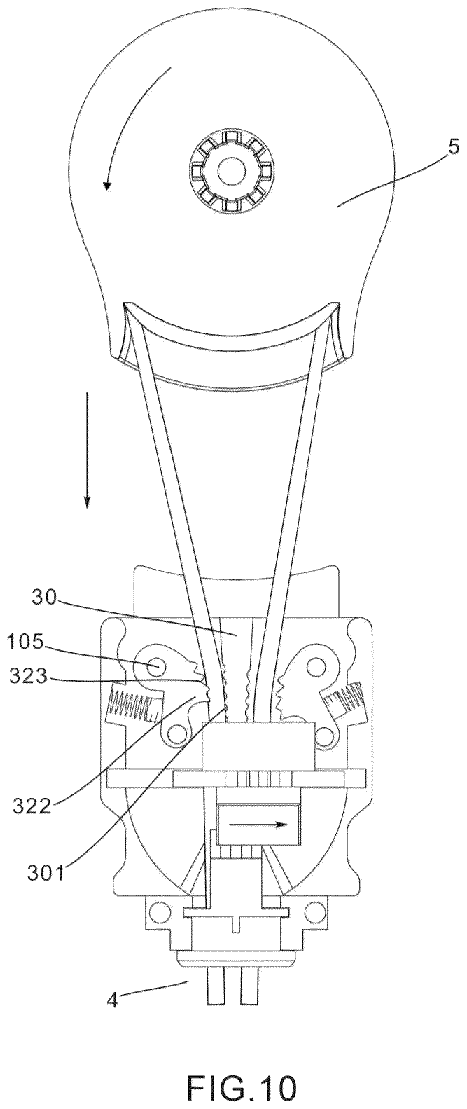

Please now refer to FIGS. 7 to 10, which show the operation of the present invention. When the roller shade is operated and controlled to move upward or downward, a protection board 50 of lower end of the cord winder 5 is clamped between the locating plate 103 and the locating body 111 of the upper end of the switch box 1 (with reference to FIG. 7). The switch box 1 is stopped by the protection board 50 so that the control rod 4 can be conveniently rotated without rotating the switch box 1 along with the control rod 4. When it is desired to upward wind the roller shade (with reference to FIG. 9), the control rod 4 is counterclockwise rotated. At this time, the engagement bodies 400 of the drive body 40 of the upper end of the control rod 4 is synchronously moved to drive the linking seat 332 of the slide seat 33 to rightward transversely move. At the same time, the push body 335 of the slide seat 33 is synchronously rightward transversely moved. In addition, the cap body 115 is disposed on the bottom of the receiving sink 113 and the elastic member 116 elastically pushes the cap body 115 to make the abutment column 114 thereof forward abut against the engagement teeth 334 and locate (with reference to FIG. 8) so as to prevent the slide seat 33 from further displacing. The push body 335 pushes the boss body 311 of the lower side of the first clamp block 31 to move, whereby the first clamp block 31 counterclockwise rotates around the protruding post 104 of the first case body 10. At the same time, the protruding block 312 is downward displaced along an arcuate line along with the first clamp block 31, whereby the clamp teeth 313 of the protruding block 312 and the restriction recess 315 formed along the middle line of the clamp teeth 313 are moved away from the cord section, while the second clamp block 32 is not pushed by the push body 335, which is rightward transversely moved. At this time, the spring 324 applies elastic force to the second clamp block 32 to push the boss body 321 of the lower side of the second clamp block 32, whereby the second clamp block 32 is counterclockwise rotated around the protruding post 105 of the first case body 10. At the same time, the protruding block 322 is upward displaced along an arcuate line along with the second clamp block 32. Accordingly, the clamp teeth 323 of the protruding block 322 and the curved edges produced on two sides of the restriction recess 325 formed along the middle line of the clamp teeth 323 together hold and bite a cord knot of the surface of the drive cord 2 to clog the cord section thereof. Therefore, the direction of the cord section is restricted by the restriction recess 325 and the clamp teeth 323 and the row of dentations 301 of the guide seat 30 clamp the cord section from two sides to form a pull end. Under such circumstance, the control rod 4 and the switch box 1 can be used to together pull the cord section downward (with reference to FIG. 10) to drive the cord winder 5 to counterclockwise rotate and make the roller shade move upward.

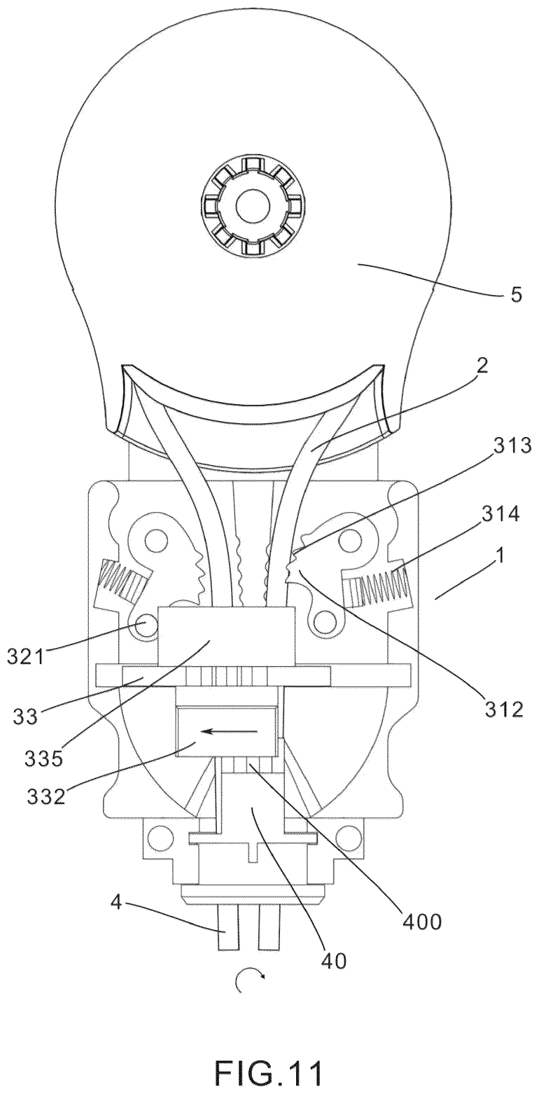

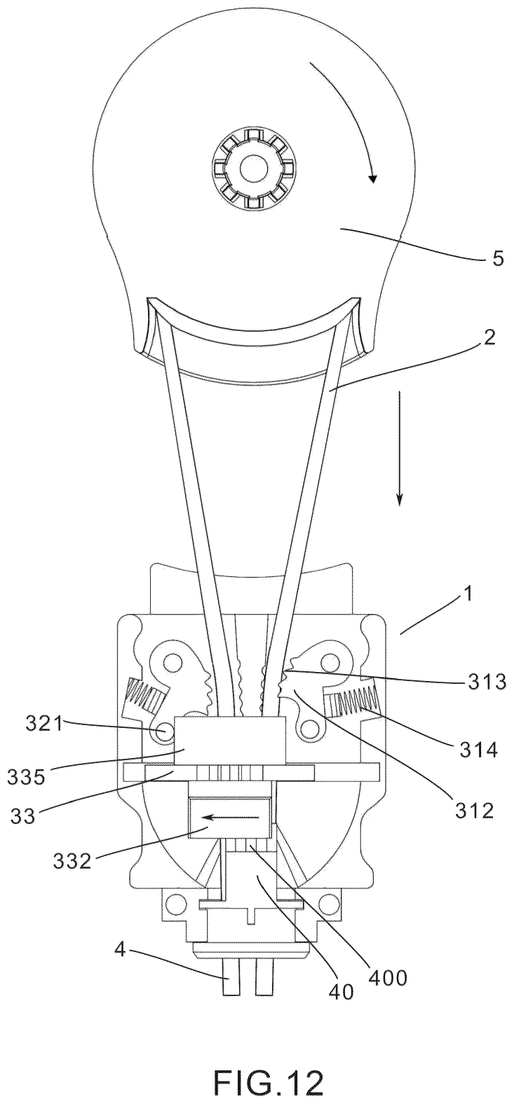

When it is desired to operate and move the roller shade downward (with reference to FIG. 11), the control rod 4 is reversely operated. That is, the control rod 4 is clockwise rotated. At this time, the engagement bodies 400 of the drive body 40 of the upper end of the control rod 4 is synchronously moved to drive the linking seat 332 of the slide seat 33 to leftward transversely displace. At the same time, the slide seat 33 is synchronously leftward transversely moved. Identically, the abutment column 114 of the cap body 115 disposed on the bottom of the receiving sink 113 abuts against the engagement teeth 334 of the slide seat 33 and locate (with reference to FIG. 8) so as to prevent the slide seat 33 from further displacing. The push body 335 pushes the boss body 321 of the lower side of the second clamp block 32 to move, whereby the second clamp block 32 clockwise rotates around the protruding post 105 of the first case body 10. At the same time, the protruding block 322 is downward displaced along an arcuate line along with the second clamp block 32, whereby the clamp teeth 323 of the protruding block 322 and the restriction recess 325 formed along the middle line of the clamp teeth 323 are moved away from the cord section, while the first clamp block 31 is not pushed by the push body 335, which is leftward transversely moved. At this time, the spring 314 applies elastic force to the first clamp block 31 to push the boss body 311 of the lower side of the first clamp block 31, whereby the first clamp block 31 is clockwise rotated around the protruding post 104 of the first case body 10. At the same time, the protruding block 312 is upward displaced along an arcuate line along with the first clamp block 31. Accordingly, the clamp teeth 313 of the protruding block 312 and the curved edges produced on two sides of the restriction recess 315 formed along the middle line of the clamp teeth 313 together hold and bite a cord knot of the surface of the drive cord 2 to clog the cord section thereof. Therefore, the direction of the cord section is restricted by the restriction recess 315 and the clamp teeth 313 and the row of dentations 300 of the guide seat 30 clamp the cord section from two sides to form a pull end. Under such circumstance, the control rod 4 and the switch box 1 can be used to together pull the cord section downward (with reference to FIG. 10) to drive the cord winder 5 to clockwise rotate and make the roller shade move downward (with reference to FIG. 12).

The above embodiments are only used to illustrate the present invention, not intended to limit the scope thereof. Many modifications of the above embodiments can be made without departing from the spirit of the present invention.

What is claimed is:

1. A controller for controlling ascending/descending of a roller shade, comprising a switch box, a drive cord, a cord biting unit and a control rod, the switch box being composed of a first case body and a second case body assembled with each other, two protruding posts being disposed on an inner face of the first case body, the drive cord being conducted through the switch box to connect with a spring and together with the spring concealed in the control rod under a lower end of the switch box, whereby two cord sections of the drive cord are enclosed in the switch box and controlled by the cord biting unit, the cord biting unit being mounted in the switch box, the cord biting unit including a guide seat and a clamp block set, the guide seat being disposed at the opening of the upper end of the switch box, two rows of dentations being disposed on two sides of the guide seat, the opening of the upper end of the switch box being divided by the guide seat into two inlets for separating the drive cord, the clamp block set including a first clamp block and a second clamp block, the first and second clamp blocks being respectively formed with two through holes, the protruding posts of the first case body being fitted in the through holes, whereby the first and second clamp blocks can be respectively displaced along an arcuate line, multiple clamp teeth being disposed on one side of the first clamp block, a restriction recess being formed along a middle line of the clamp teeth, whereby curved edges are produced on two sides of the restriction recess, multiple clamp teeth being disposed on one side of the second clamp block, a restriction recess being formed along a middle line of the clamp teeth, whereby curved edges are produced on two sides of the restriction recess, a boss body being secured to a lower end of each of the first and second clamp blocks, a slide seat being transversely movably mounted in the switch box, a push body protruding from an upper end of the slide seat, two sides of the push body respectively corresponding to the boss bodies of the lower ends of the first and second clamp blocks, a linking seat being disposed at one end the slide seat opposite to the push body, the linking seat being drivingly engaged with the control rod, whereby by means of rotating the control rod, the slide seat is driven to transversely displace toward one side so as to selectively push any of the first and second clamp blocks to rotate along an arcuate line, at this time, the clamp teeth and restriction recess of the clamp block being moved downward or upward along the arcuate line, whereby the clamp teeth and the curved edges produced on two sides of the restriction recess together hold and bite a cord knot of the surface of one of the cord sections, and the clamp teeth and the row of dentations of the guide seat clamp the cord section from two sides, the control rod being used to pull the bitten cord section of the drive cord so as to drive a cord winder to clockwise or counterclockwise rotate and control the roller shade to move upward or downward.

2. The controller for controlling ascending/descending of a roller shade as claimed in claim 1, wherein the clamp teeth of the protruding blocks of the first and second clamp blocks have different depths.

3. The controller for controlling ascending/descending of a roller shade as claimed in claim 1, wherein the clamp teeth of the protruding blocks of the first and second clamp blocks are positioned on different arcuate lines.

4. The controller for controlling ascending/descending of a roller shade as claimed in claim 1, wherein the clamp teeth of the protruding blocks of the first and second clamp blocks correspond to the two rows of dentations of the guide seat for clamping the drive cord.

5. The controller for controlling ascending/descending of a roller shade as claimed in claim 1, wherein a board block extends from a lower end of each of the first and second clamp blocks and a boss body is secured to board block.

6. The controller for controlling ascending/descending of a roller shade as claimed in claim 1, wherein the guide seat and the first case body are formed as an integrated structure.
